(19) United States
(12) Patent Application Publication
(10) Pub. No.: US 2006/0149584 A1
(43) Pub. Date: Jul. 6, 2006

(54) Hangover-mitigating nutritional supplement dispensing system

(76) Inventor: Steven C. Smith, Dade City, FL (US)

Correspondence Address: Steven C. Smith, 37541 Church Ave, Dade City, FL, 33525, US

(21) Appl. No.: 11/271,472

(22) Filed: Nov. 10, 2005

Related U.S. Application Data
(60) Provisional application No. 60/626,821, filed on Nov. 10, 2004.

(51) Int. Cl. G06Q 99/00

(52) U.S. Cl. 705/1

(57) ABSTRACT

A system for providing for display/dispensing of a nutritional supplement useful in mitigating the deleterious effects of over-imbibation at a location convenient to guests at an overnight accommodation, and can include providing same in guest rooms and can include providing for adding a cost of use of same to the cost of accommodation.

### BACKGROUND OF THE INVENTION

1. Field of the Invention

The present invention relates generally to system for providing for meeting the needs of guests at overnight accommodations. More particularly, the present invention relates to on-site and in-room dispensing systems.

2. Related Art

Providing for the comfort and convenience of guests at overnight accommodations, including but not limited to hotels, motels, resorts, casinos, and the like, is typically an important goal of proprietors of such establishments. For example, in-room provision of snacks, alcoholic and non-alcoholic drinks, and other consumables is not unusual; and numerous systems for accounting for, and payment for, guest consumption of such things which are thus provided are known.

As will be recognized by most people skilled in the art, people staying in overnight accommodations often drink alcoholic beverages incident to activities giving rise to their stay. It may be fair to say that alcohol consumption may be higher under such circumstances than it would be at home for many, if not a majority, of guests. In other words, people typically drink more when they are staying at guest accommodations, particularly when they are not required to drive before returning to a guest room. For example such may be the case with respect to casino guest rooms, or at resorts, or at conventions held at (or a short walk from) the guest accommodations, to name some specific circumstances.

As mentioned, at a typical establishment facilitating overnight accommodation many things for the convenience of guests are provided, yet typically the resources available to guests for mitigation of the effects of over-imbibation are less at overnight accommodations than would be available back at the home of the typical guest. For example, most in-room provisions do not include remedies that would be available in a typical home bar, medicine cabinet, kitchen, etc.

In other words, people typically drink more when they are away from home, and this inclination to drink more alcohol may be recognized by those in the hotel/resort industry; but it will also be recognized that resources typically provided to guests by proprietors of overnight accommodations do not specifically address this issue of increased drinking of alcohol.

### SUMMARY

It had been recognized be the inventor that it would be advantageous to develop a method for providing hangover mitigation resources at a point of need heretofore not addressed, specifically, in common areas and in guest rooms of overnight accommodations.

The invention includes providing a display alerting guests to the presence of nutritional supplements helpful in mitigation of the effects of over-imbibation. It includes providing supplements at the display. It can include providing a notification that if packaging of the supplements is opened that a charge in a stated amount will be added to the charge for accommodation of guests for a night. It can include checking to see if a package of nutritional supplement that was provided has been opened or removed from the display. It can include adding a charge for use of said nutritional supplements to the bill of a guest.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a front perspective view of an example display/dispenser apparatus in accordance with an embodiment of the present invention;

FIG. 2 is a front perspective view of the example apparatus shown in FIG. 1 with a product package removed;

FIG. 3 is a rear perspective view of the apparatus shown in FIG. 1; and

FIG. 4 is a flow diagram illustrating an example method in accordance with the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modification of the inventive features illustrated herein, and additional applications of the principles of the inventions as illustrated herein, which would occur to one skilled in the relevant art and having possession of this disclosure, are to be considered within the scope of the invention.

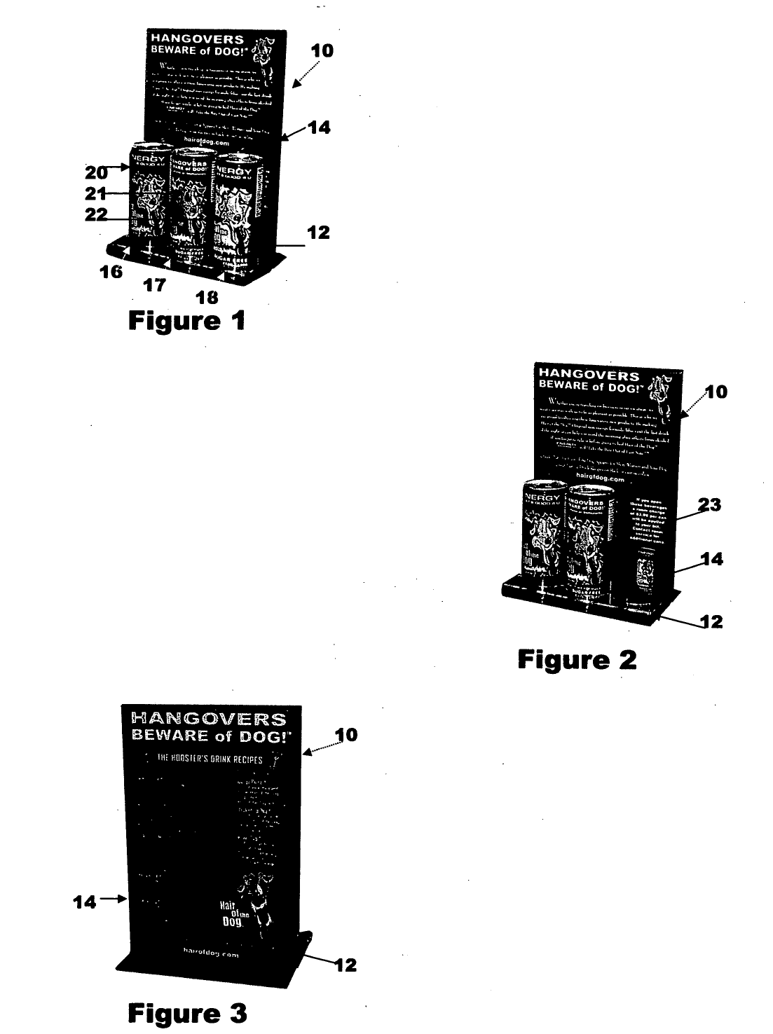

As illustrated in FIG. 1, an example in-room dispensing system 10 in accordance with the invention is configured to alert guests of the availability of hangover mitigation nutritional supplements, and to hold packages of same. The system is configured to sit on a surface, such as a table or credenza, ledge, counter or the like, likely to be found in a hotel check in/out counter area, a guest room, suite, bathroom, etc. and be prominently visible to guests.

In accordance with one aspect of the present invention, the system 10 includes a display/dispensing stand 12 in the example illustrated this is formed of a sheet of transparent polymeric resin which is heated and formed into the shape illustrated. This accommodates a sign card 14, which can be changed out if desired. The sheet comprising the stand can include indentations defined by one edge 16 folded back to define individual packaging retention areas 16, 17, 18, holding packages (here, cans) 20, 21, 22 of nutritional supplement product helpfule in mitigation of the deleterious effects of over-imbibation.

With reference to FIGS. 1 and 3, the sign card 14 can alert guests to the availability of the product, and can state the terms and conditions upon which the guest can use the product. For example the sign card can alert the guest to a cost per package used or opened. It can inform the guest that this cost will be added to the cost of accommodation. The sign card can include other helpful information, such as a website address where further information about the product can be found, drink mix recipes for incorporation of the nutritional supplement in a drink, suggestions for further mitigation measures for hangover, to name some examples.

With reference to FIG. 2 in the illustrated example, when a package is removed from the display/dispenser stand 12, a portion of 23 of the sign card 14 explaining the terms and conditions of use is revealed. For example, in the illustrated embodiment the guest can read that the product cost per package is a set amount, e.g. three dollars. Further, notification that the cost will be added to the room bill automatically if a package (e.g. 22 in FIG. 1) is removed or opened can be included.

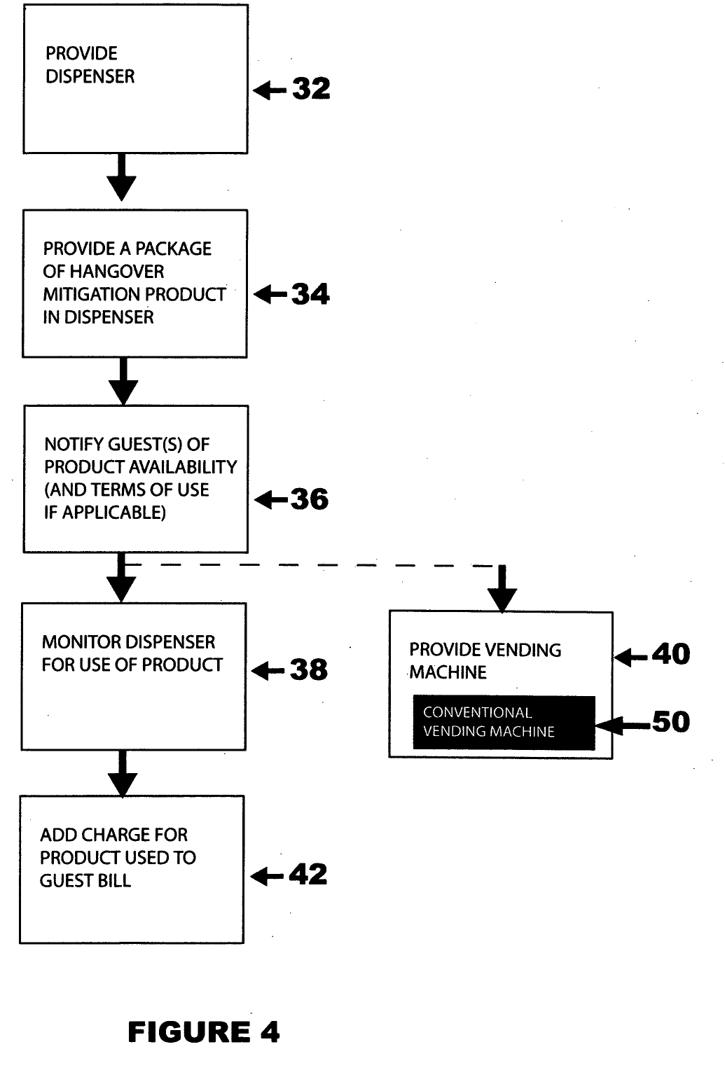

With reference to FIG. 4, in one example a method 30 for providing a hangover-mitigation nutritional supplement conveniently to guests of overnight accommodation includes the step 32 of providing a dispenser for one or more packages of said nutritional supplement which can be placed in guest rooms or otherwise convenient to guests where use of the packages can be monitored. Another step 34 includes the step of providing one or more packages of said nutritional supplement in the dispenser. Providing a notification to guest of the presence, nature, and terms of use of the package of nutritional supplements is done in another step, 36. In step 38, the dispenser is monitored for use of opening the packaged supplements. This can be by staff checking/cleaning a guest room in which the dispenser is place, or by automated means

(not shown), or by clerks or other staff when the dispenser is placed in a commons area such as a check in/out counter. In another embodiment, in a different step 40, a conventional coin/bill-operated dispensing machine can be used as discussed below. In step 42 a charge for the package used can be added to a guest bill when the monitoring step discloses use of the package or opening it or otherwise rendering it unusable by another guest. As will be appreciated, in one example the supplement can be provided as a courtesy, and without charge by the proprietor of the overnight accommodations, and in another a charge can be made, providing for the cost of implementation of the method, and in one embodiment for returning a profit to the proprietor or others.

As mentioned in one embodiment the display/dispenser can comprise a vending machine 50 as mentioned in connection with step 40 above. This can be located in the lobby or hall or other common/public area and need not be monitored as closely as with other embodiments, but for re-filling product prior to running out and otherwise as conventionally done in vending machine dispensing. Such a machine can also be placed in a guest room, providing convenient access for guests, in situations where daily room use monitoring is not desirable. As will be appreciated the hangover-mitigation supplement can be one of several products in such a vending dispenser in one embodiment, but in any case notification to the guest of the availability of the hangover mitigation product, and convenient access at the place of guest accommodation are features that can be provided be the method.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most preactival and preferred embodiment(s) of the invention, it will be apparent to those of ordinary skill in the art that numerous modification can be made without departing from the principles and concepts of the invention as set forth herein.

I claim the following:

1. A method for providing hangover mitigation resources in common areas and in guest rooms of overnight accommodations comprised of the following steps:
Providing a display alerting guests to the presence of nutritional supplements helpful in mitigation of the effects of over-imbibation; and
Providing supplements at the display

2. The method of claim 1 wherein the display has interchangeable signs

3. The method of claim 1 with the additional step of providing a notification that if packaging of the supplements is opened that a charge in a stated amount will be added to the charge for accommodation of guests for a night

4. The method of claim 1 plus the additional step of the automated or manual checking to see if a package of nutritional supplement that was provided has been opened or removed from the display

5. The method of claim 1 plus the additional step of adding a charge for use of said nutritional supplements to the bill of a guest

6. The method of claim 3 plus the additional step of the automated or manual checking to see if a package of nutritional supplement that was provided has been opened or removed from the display

7. The method of claim 3 plus the additional step of adding a charge for use of said nutritional supplements to the bill of a guest

8. The method of claim 4 plus the additional step of adding a charge for use of said nutritional supplements to the bill of a guest.
